(19) United States
(12) Patent Application Publication
(10) Pub. No.: US 2024/0060551 A1
(43) Pub. Date: Feb. 22, 2024

(54) LINEAR ACTUATOR HAVING WOBBLE JOINT

(71) Applicant: JTEKT Bearings North America LLC, Greenvillle, SC (US)

(72) Inventors: Justin K. Brubaker, Greenville, SC (US); William A. Dammers, Greenville, SC (US)

(21) Appl. No.: 18/235,421

(22) Filed: Aug. 18, 2023

Related U.S. Application Data
(60) Provisional application No. 63/399,343, filed on Aug. 19, 2022.

(51) Int. Cl. F16H 25/22; F16H 25/24; F16D 65/18

(52) U.S. Cl. CPC F16H 25/2204; F16H 25/24; F16D 65/18; F16D 55/226

(57) ABSTRACT

A screw-type linear actuator comprises a support structure and a screw shaft that is axially stationary with respect to the support structure but rotatably drivable. A nut is mounted on the screw shaft such that rotation of the screw shaft causes axial movement of the nut along the screw shaft. In addition, the screw shaft defines a first annular contact surface having a spherical profile with a first radius. A thrust flange is located on the screw shaft for rotation with the screw shaft, the thrust flange having a second annular contact surface with a second radius, the first annular contact surface engaging the second annular contact surface.

### PRIORITY CLAIM

This application is based upon and claims priority to U.S. provisional application No. 63/399,343 filed Aug. 19, 2022, which is incorporated fully herein by reference for all purposes.

### FIELD OF THE INVENTION

The present invention relates generally to linear actuators. More particularly, aspects of the present invention relate to screw-type actuators such as ball screws.

### BACKGROUND OF THE INVENTION

Various applications utilize linear actuators such as screw-type actuators. For example, typical electro-mechanical brake systems require actuators that can provide a linear force. An example linear actuator is a ball screw assembly including a ball train interposed between a ball track formed in an outer surface of a ball screw shaft and a ball track formed in an inner surface of a ball screw nut. Ball screw assemblies of the recirculating ball type and non-recirculating ball type are known.

Such linear actuators may have a wobble joint that has a spherical shape on the shaft and cone contact on a flange that is engaged by the spherical shape. An example of such an arrangement is shown in FIGS. 7A and 7B, where it can be seen that the wobble joint (A) has an annular face (B) with a spherical shape formed on the shaft (C). The spherical shape engages a frustoconical contact surface (D) formed on the flange (E). In this configuration, misalignment mitigation is limited as when higher axial loads are encountered, friction often causes the joint to lock up prior to full working load and deflection.

The present invention recognizes and addresses considerations of prior art constructions and methods.

### SUMMARY OF THE INVENTION

One embodiment of the present disclosure provides a screw-type linear actuator comprising a support structure and a screw shaft that is axially stationary with respect to the support structure but rotatably drivable. A nut is mounted on the screw shaft such that rotation of the screw shaft causes axial movement of the nut along the screw shaft. In addition, the screw shaft defines a first annular contact surface having a spherical profile with a first radius. A thrust flange is located on the screw shaft for rotation with the screw shaft, the thrust flange having a second annular contact surface with a second radius, the first annular contact surface engaging the second annular contact surface.

According to some exemplary embodiments, the first radius has a first center point coincident with a longitudinal center axis of the screw shaft. In addition, the second radius may have a second center point offset from the longitudinal center axis of the screw shaft. The second radius may be greater than the first radius.

According to some exemplary embodiments, a thrust bearing may be situated between the thrust flange and the support structure. In addition, a bearing disc may be fixed to the support structure.

According to some exemplary embodiments, the linear actuator may comprise a ball screw assembly having a plurality of balls located between opposing ball tracks defined in the screw shaft and the nut. For example, the ball screw assembly may comprise a non-recirculating ball screw assembly.

Another aspect of the present invention provides a screw-type linear actuator comprising a support structure and a screw shaft that is axially stationary with respect to the support structure but rotatably drivable. A nut is mounted on the screw shaft such that rotation of the screw shaft causes axial movement of the nut along the screw shaft. In addition, the screw shaft defines a first annular contact surface having a spherical profile with a first radius. A thrust flange is located on the screw shaft for rotation with the screw shaft, the thrust flange having a second annular contact surface with a second radius, the first annular contact surface engaging the second annular contact surface. In addition, a thrust bearing is situated between the thrust flange and the support structure. The first radius has a first center point coincident with a longitudinal center axis of the screw shaft and the second radius has a second center point offset from the longitudinal center axis of the screw shaft.

A still further aspect of the present invention provides a brake apparatus comprising a brake caliper having a body with a brake cylinder. A piston is located in the brake cylinder. A first pad is fixed with respect to an end of the piston and a second pad is opposed to the first pad.

The brake apparatus further comprises a screw-type linear actuator including a screw shaft that is axially stationary with respect to the brake caliper but rotatably drivable. A nut is mounted on the screw shaft such that rotation of the screw shaft causes axial movement of the nut along the screw shaft, the nut being connected to the piston so as to cause axial movement of the piston. The screw shaft defines a first annular contact surface having a spherical profile with a first radius. A thrust flange is located on the screw shaft for rotation with the screw shaft, the thrust flange having a second annular contact surface with a second radius, the first annular contact surface engaging the second annular contact surface. A thrust bearing is situated between the thrust flange and the brake caliper. The first radius has a first center point coincident with a longitudinal center axis of the screw shaft and the second radius has a second center point offset from the longitudinal center axis of the screw shaft.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIG. 1 is a schematic view of a brake assembly that may utilize an embodiment of a ball screw assembly in accordance with an aspect of the present disclosure;

FIG. 2 is a perspective, partial cross-sectional view of a ball screw assembly that may be utilized in the brake assembly of FIG. 1;

FIG. 3 is a perspective, cross-sectional view of the ball nut of the ball screw assembly shown in FIG. 2;

FIG. 4 is a side partial cross-sectional view of the ball screw assembly shown in FIG. 2;

FIGS. 5A and 5B are partial cross-sectional views of the ball screw assembly shown in FIGS. 2 through 4 showing details of the wobble joint;

FIG. 6 is a schematic illustration of the wobble joint of the ball screw assembly shown in FIGS. 5A and 5B; and

FIGS. 7A and 7B are views of a wobble joint in a prior art ball screw assembly.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

Aspects of the present invention are particularly applicable to various screw-type actuators in which an axially-movable portion moves linearly with respect to an axially stationary portion. For example, the axially movable portion may be in the form of a nut that moves back and forth along a screw shaft, depending on the screw shaft's direction of rotation. Various screw-type actuators may utilize teachings of the present invention, including ball screws (recirculating and non-recirculating), lead screws (including planetary lead screws), and roller screws.

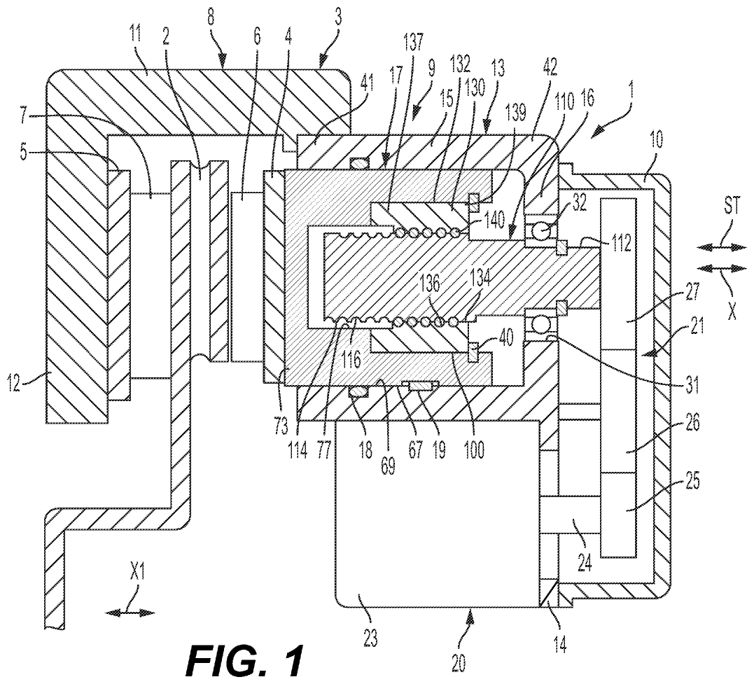

In this regard, FIG. 1 shows an exemplary application in which principles of the present invention may be employed. As illustrated, a brake assembly 1 includes a linear actuator in the form of a ball screw assembly 100. The brake assembly 1 selectively applies a frictional braking force to a disc 2 rotating integrally with a wheel of an automobile or the like. The brake apparatus 1 includes a caliper 3, a first backup plate 4, a second backup plate 5, a first pad 6, and a second pad 7. The caliper 3 is movably supported by a knuckle (not shown), and the first backup plate 4 and the second backup plate 5 are disposed on the caliper 3 so as to sandwich the brake disc 2 therebetween. The first pad 6 and the second pad 7 are fixed to the first backup plate 4 and the second backup plate 5, respectively, and can press respective side surfaces of the disc 2.

The caliper 3 includes a first body 8, a second body 9, and a cover 10. The first body 8 and the second body 9 are fixed together. The cover 10 is fixed to the second body 9. The first body 8 includes a body portion 11 and an arm portion 12. One end of the second body 9 is fixed to the body portion 11. The arm portion 12 is coupled orthogonally to the body portion 11. The second backup plate 5 is fixed to the arm portion 12. The second body 9 includes a brake cylinder 13 and an extension plate 14. The cylinder 13 is fixed to the body portion 11 of the first body 8. The extension plate 14 extends from the cylinder 13.

The cylinder 13 has a first end 41 and a second end 42 that are opposite to each other in an axial direction. The cylinder 13 includes a cylindrical portion 15 that is open at the first end 41 and an end surface plate 16 coupled to the second end 42 of the cylindrical portion 15. A piston 17 that is movable in the axial direction ST is housed in the cylinder 13. An end 73 of the piston 17 protrudes toward the disc 2 through an opening at an end of the cylinder 13 (that corresponds to the first end 41 of the cylindrical portion 15). The first backup plate 4 is fixed to the end 73 of the piston 17.

A seal member 18 is interposed between a cylindrical outer surface 67 of the piston 17 and an inner surface of the cylinder 13 (that corresponds to an inner surface 69 of the cylindrical portion 15) to seal the gap between the outer surface 67 and the inner surface 69. The seal member 18 may be an O-ring housed in a housing groove formed in the inner surface 69 of the cylinder 13. The outer surface 67 of the piston 17 and the inner surface 69 of the cylinder 13 are coupled together via a key 19 provided in keyways formed in the outer surface 67 and the inner surface 69. Key coupling using the key 19 allows movement of the piston 17 in the axial direction ST to be guided and also prevents rotation of the piston 17 with respect to the cylinder 13.

The caliper 3 functions to press both of the pads 6 and 7 against the disc 2 to generate a braking force. Toward this end, brake assembly 1 includes a linear actuator that functions to move piston 17 in the axial direction. In this case, the linear actuator is a form of screw-type actuator, namely a non-recirculating ball screw assembly 100. Toward this end, the caliper 3 further includes an electric motor 20 and a speed reduction apparatus 21. The speed reduction apparatus 21 reduces the rotation speed of the electric motor 20. The ball screw assembly 100 converts rotary motion transmitted from the electric motor 20 via the speed reduction apparatus 21 into linear motion of the piston 17 in the axial direction ST.

The electric motor 20 includes a motor housing 23 and an output shaft 24. The motor housing 23 is fixed to the extension plate 14 of the second body 9. The speed reduction apparatus 21 includes a driving gear 25, an idle gear 26, and a driven gear 27. The driving gear 25 is attached to one end of the output shaft 24 of the electric motor 20 so as to rotate together with the output shaft 24. The idle gear 26 meshes with the driving gear 25. The driven gear 27 meshes with the idle gear 26. The idle gear 26 is pivotally supported by the second body 9 so as to be rotatable. The cover 10 is fixed to the second body 9 so as to cover the speed reduction apparatus 21.

The ball screw assembly 100 includes a ball screw shaft 110 and a ball nut 130. The ball screw shaft 110 is an input member. The ball nut 130 is an output member screwed on the ball screw shaft 110 via a plurality of main balls 140. The ball screw shaft 110 extends through the ball nut 130, as shown. The ball screw shaft 110 is supported by the second body 9 so as to be immovable in the axial direction but to be rotatable. The ball nut 130 is supported by the piston 17 so as to be movable in the axial direction as the ball screw shaft 110 rotates but the ball nut 130 is non-rotatable.

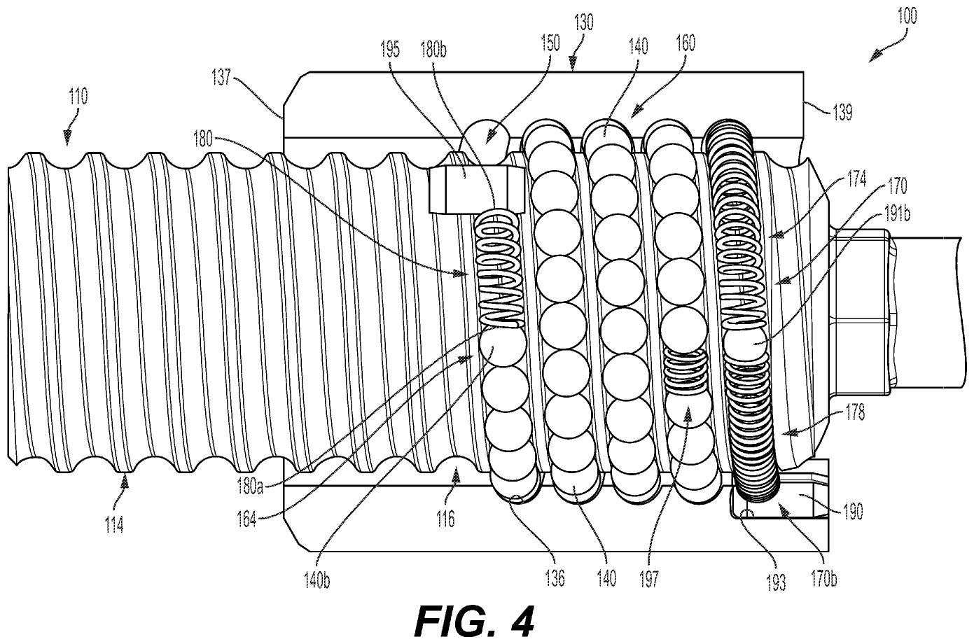

As can be seen, an end of screw shaft 110 extends through a hole 31 formed in the end surface plate 16 of the body 9. A bearing 32 facilitates rotation between screw shaft 110 and cylinder 13. Bearing 32 is shown in this schematic image as a simple ball bearing but various needle bearings and/or thrust bearings will often be used as shown below. The driven gear 27 is coupled to an end 112 of the ball screw shaft 110 so as to rotate together with the ball screw shaft 110. As shown, the ball nut 130 has a cylindrical outer surface 132 and an inner surface 134. A ball track 136 is formed in the inner surface 134. The ball screw shaft 110 has a cylindrical outer surface 114 in which a ball track 116 is formed. The main balls 140 forming a ball train are disposed in a ball raceway 150 (FIG. 4) defined between ball track 116 and ball track 136.

The outer surface 132 of the ball nut 130 is fitted within the cylindrical inner surface portion of the piston 17. As one skilled in the art will appreciate, features (such as keys, splines, etc.) are preferably provided so that ball nut 130 will not rotate with respect to piston 17. (Although piston 17 and nut 130 are here shown as separate pieces, embodiments are contemplated in which nut 130 and piston 17 are formed as a unitary piece.) The ball nut 130 includes a first end 137 closer to the disc 2 and a second end 139 opposite from the first end 137, in a ball nut axial direction X. In the embodiment shown, a retaining ring (annular member) 40 fitted in an annular groove formed in the inner surface 77 of the piston 17 is engaged with an end surface of the second end 139 of the ball nut 130. Embodiments are contemplated, however, that do not utilize such a retaining ring 40.

When rotation of the output shaft 24 of the electric motor 20 is transmitted to the ball screw shaft 110 via the speed reduction apparatus 21 to rotate the ball screw shaft 110, the ball nut 130 moves in the ball nut axial direction X (axial direction ST). At this time, the piston 17 is guided by the key 19 and moves together with the ball nut 130 in the axial direction ST.

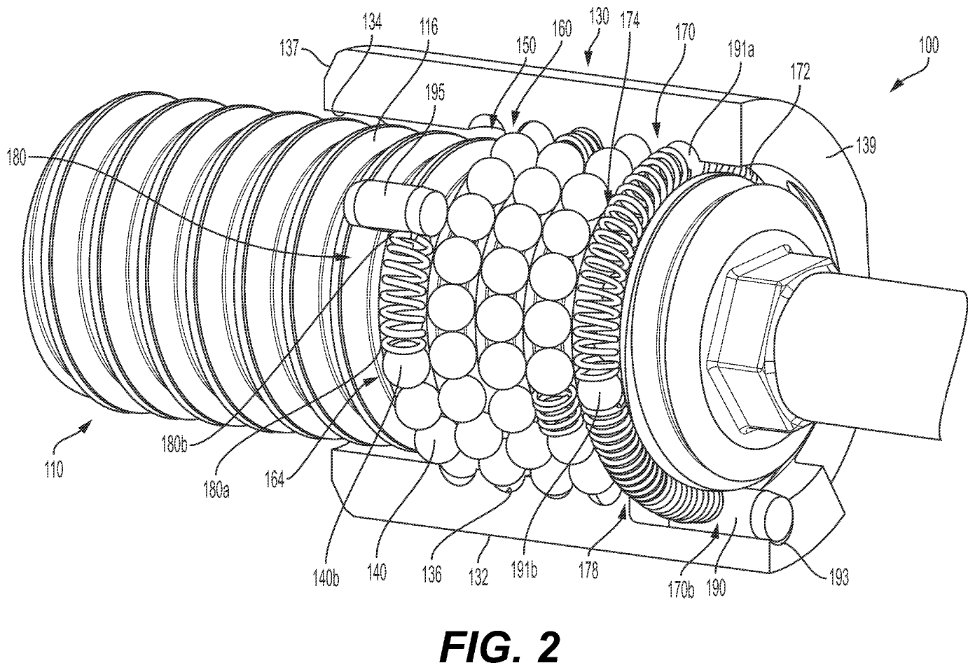

FIGS. 2-4 illustrate certain aspects of an exemplary ball screw assembly 100 that may be used in various embodiments of the present invention. In this case, ball screw assembly 100 is formed as a non-recirculating ball screw similar in certain respects to that disclosed in U.S. Pat. No. 11,536,335, incorporated herein by reference in its entirety for all purposes. As shown, a plurality of main balls 140 are held in the ball raceway 150 form a ball train 160. The ball train 160 includes a first end 162 (FIG. 4) and a second end 164. One or more link springs 197 may be disposed between adjacent main balls 140 of the ball train 160. The ball screw assembly 100 includes a main coil spring assembly 170 and a return coil spring 180 disposed on the respective opposite sides of the ball train 160 in the raceway 150.

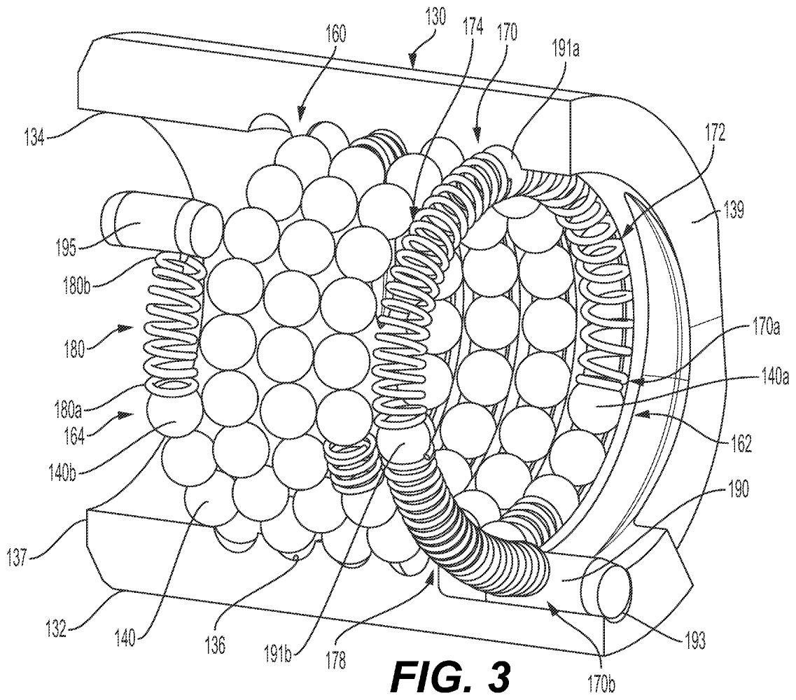

As best seen in FIGS. 3 and 4, the main coil spring assembly 170 includes a first end 170a and a second end 170b. The first end 170a engages with a main ball 140a at a first end 162 of the ball train 160. The second end 170b of the main spring assembly 170 engages with a stopper pin 190 that is received in a recess 193 formed in ball nut 130 so that stopper pin 190 extends into ball raceway 150. A return coil spring 180 includes a first end 180a and a second end 180b. The first end 180a engages with a main ball 140b at the second end 164 of the ball train 160. The second end 180b of the return spring 180 engages with a stopper pin 195 that is received in a recess (not shown) that is formed in the ball nut 130 so that stopper pin 195 extends into ball raceway 150. Note, in alternate embodiments, the ball screw apparatus 100 may include a pair of stopper balls (not shown) held in the recessed portions of the ball nut 130 rather than the stopper pins. Typically, stopper balls have diameters greater than the diameter of the main balls 140 so they do not fit entirely within the ball raceway. However, the diameter of a stopper ball may be the same as the diameter of the main ball 140 or may be smaller than the diameter of the main ball 140, dependent upon the configuration of the corresponding recesses and ball raceway 150.

Still referring to FIGS. 3 and 4, the main spring assembly 170 may be formed by a plurality of coil spring portions having varying spring constants in order to promote consistent spring compression across the length of the main spring assembly 170. As shown, main spring assembly 170 in this embodiment includes a first spring portion 172 having a first spring constant (k₁), a second spring portion 174 having a second spring constant (k₂), and a third spring portion 178 having a third spring constant (k₃). The first spring portion 172 is disposed adjacent to the first end 162 of the ball train 160 and is separated from the second spring portion 174 by a first link ball 191a. The third spring portion 178 is disposed adjacent to the stopper pin 190 and is separated from the second spring portion by a second link ball 191b. Link balls 191a and 191b facilitate the motion of spring portions 172, 174, and 178 within the raceway while reducing distortion.

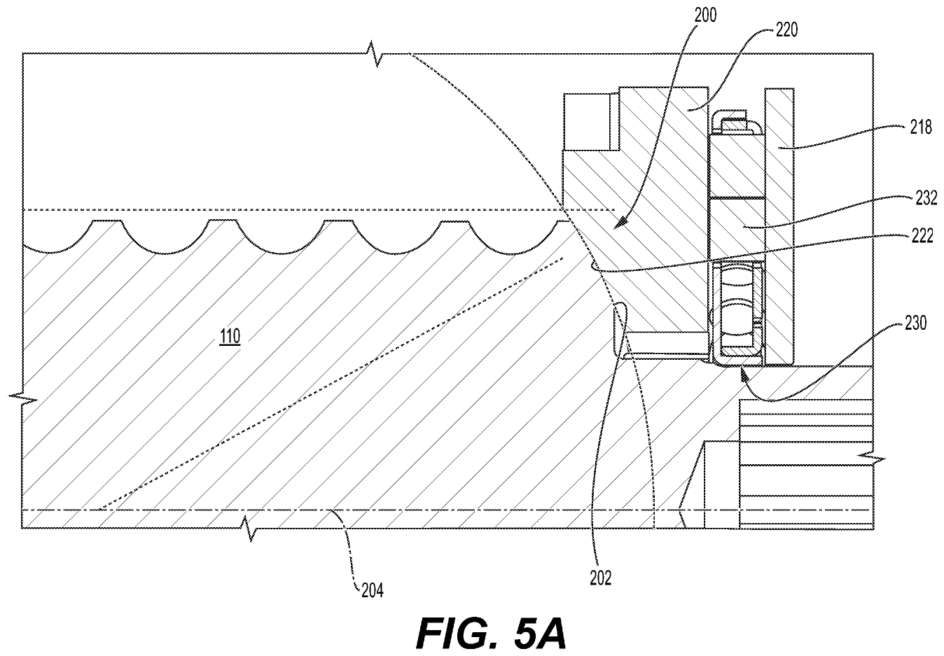

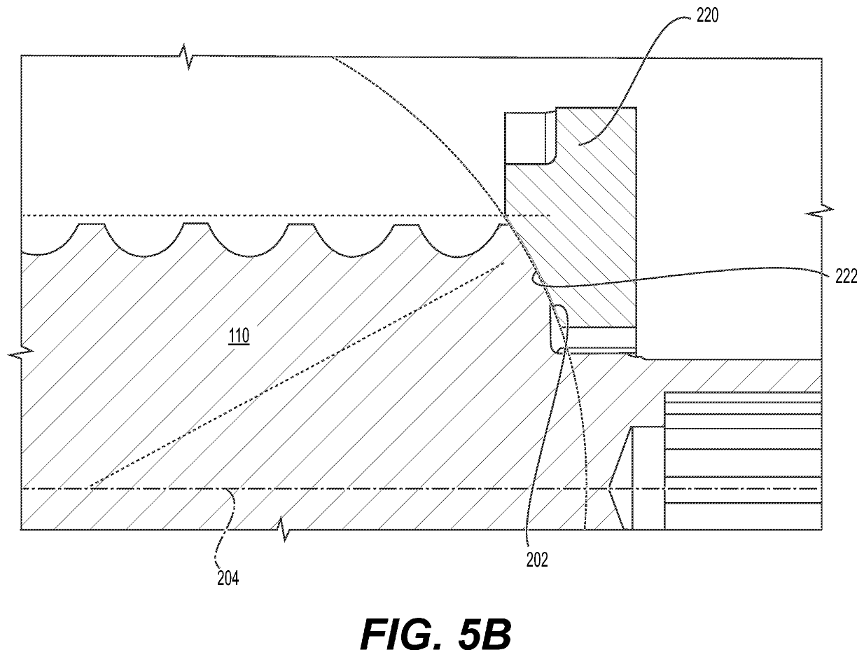

FIGS. 5A and 5B illustrate a preferred embodiment of a wobble joint 200 in accordance with aspects of the present invention. As can be seen, wobble joint 200 is formed between the ball screw shaft 110 and a thrust flange 220 which supports the axial load of the ball screw assembly 100. Preferably, the wobble joint 200 is a conforming spherical joint between the annular contact surface 202 of the ball screw shaft 110 and the annular contact surface 222 of the thrust flange 220. Preferably, thrust flange 220 is splined to shaft 110 such that they rotate together but is capable of a wobble motion with respect to shaft 110. A thrust bearing 230 having a plurality of rollers 232 facilitates rotation between the thrust flange 220 and a fixed surface such as bearing disc 218. It will be appreciated that bearing disc 218 may be a unitary portion of the end surface plate 16 or may be a separate piece fixed thereto.

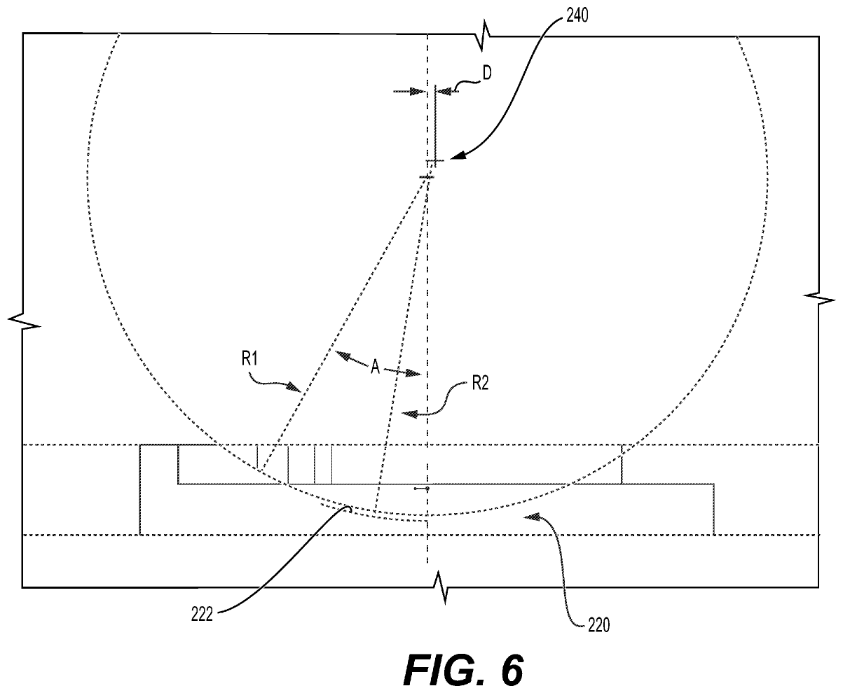

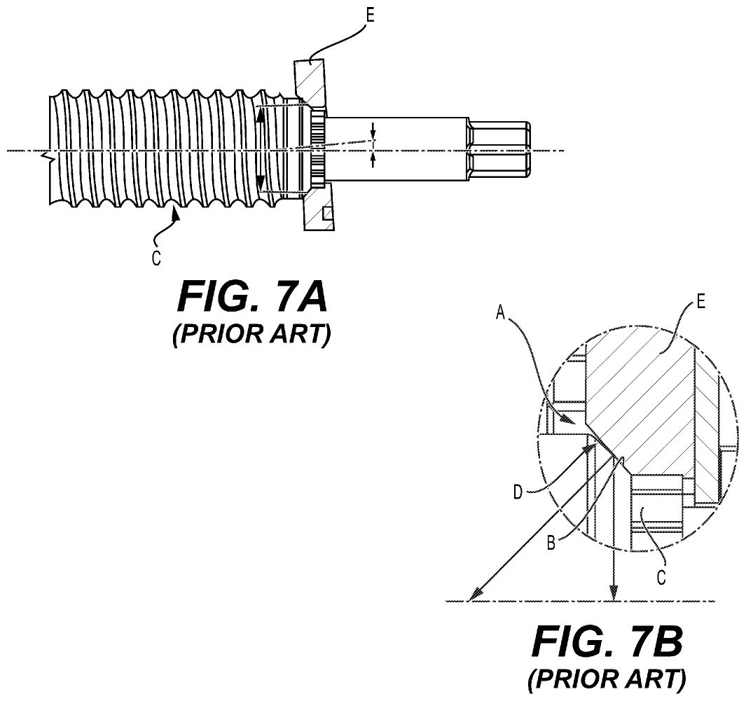

Referring now also to FIG. 6, the contact surfaces 202 and 222 both preferably have a spherical profile (i.e., their surface shapes conform to a portion of larger imaginary spheres). In this regard, contact surfaces 202 and 222 may have respective radii R1 and R2. Often it will be desirable for R2 to be slightly greater than R1. In addition, radius R1 is preferably centered on the longitudinal center axis 204 of the shaft 110. As shown, and in contrast, the center point 240 of the radius of curvature of the annular contact surface 222 of the thrust flange 220 is preferably offset from the longitudinal center axis 204 of the shaft by an offset distance D. The offset radius of curvature of the annular contact surface 222 is often referred to as a Gothic arch. This contact geometry allows for ease of movement to allow for control of misalignment between the shaft 110, the flange 220, the thrust bearing 230, and the system. For example, the thrust flange 220 is able to distort in concert with the support wall to more evenly load the thrust bearing rollers 232. The lower stress of contact in comparison with the prior art allows greater ease of movement under high loads.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

1. A screw-type linear actuator comprising:
a support structure;
a screw shaft that is axially stationary with respect to the support structure but rotatably drivable;
a nut mounted on the screw shaft such that rotation of the screw shaft causes axial movement of the nut along the screw shaft;
the screw shaft defining a first annular contact surface having a spherical profile with a first radius;
a thrust flange located on the screw shaft for rotation with the screw shaft, the thrust flange having a second annular contact surface with a second radius, the first annular contact surface engaging the second annular contact surface.

2. A screw-type linear actuator as set forth in claim 1, wherein the first radius has a first center point coincident with a longitudinal center axis of the screw shaft.

3. A screw-type linear actuator as set forth in claim 2, wherein the second radius has a second center point offset from the longitudinal center axis of the screw shaft.

4. A screw-type linear actuator as set forth in claim 3, wherein the second radius is greater than the first radius.

5. A screw-type actuator as set forth in claim 1, further comprising a thrust bearing situated between the thrust flange and the support structure.

6. A screw-type actuator as set forth in claim 5, further comprising a bearing disc fixed to the support structure.

7. A screw-type linear actuator as set forth in claim 1, wherein the linear actuator comprises a ball screw assembly having a plurality of balls located between opposing ball tracks defined in the screw shaft and the nut.

8. A screw-type actuator as set forth in claim 7, wherein the ball screw assembly comprises a non-recirculating ball screw assembly.

9. A screw-type linear actuator as set forth in claim 1, further comprising a brake piston that is movable axially by the nut.

10. A screw-type linear actuator comprising:
a support structure;
a screw shaft that is axially stationary with respect to the support structure but rotatably drivable;
a nut mounted on the screw shaft such that rotation of the screw shaft causes axial movement of the nut along the screw shaft;
the screw shaft defining a first annular contact surface having a spherical profile with a first radius;
a thrust flange located on the screw shaft for rotation with the screw shaft, the thrust flange having a second annular contact surface with a second radius, the first annular contact surface engaging the second annular contact surface; and
a thrust bearing situated between the thrust flange and the support structure,
wherein the first radius has a first center point coincident with a longitudinal center axis of the screw shaft and the second radius has a second center point offset from the longitudinal center axis of the screw shaft.

11. A screw-type linear actuator as set forth in claim 10, wherein the second radius is greater than the first radius.

12. A screw-type actuator as set forth in claim 11, further comprising a bearing disc fixed to the support structure.

13. A screw-type linear actuator as set forth in claim 10, wherein the linear actuator comprises a ball screw assembly having a plurality of balls located between opposing ball tracks defined in the screw shaft and the nut.

14. A screw-type actuator as set forth in claim 13, wherein the ball screw assembly comprises a non-recirculating ball screw assembly.

15. A brake apparatus comprising:
a brake caliper having a body with a brake cylinder;
a piston located in the brake cylinder;
a first pad fixed with respect to an end of the piston;
a second pad opposed to the first pad;
a screw-type linear actuator including:
a screw shaft that is axially stationary with respect to the brake caliper but rotatably drivable;
a nut mounted on the screw shaft such that rotation of the screw shaft causes axial movement of the nut along the screw shaft, the nut being connected to the piston so as to cause axial movement of the piston;
the screw shaft defining a first annular contact surface having a spherical profile with a first radius;
a thrust flange located on the screw shaft for rotation with the screw shaft, the thrust flange having a second annular contact surface with a second radius, the first annular contact surface engaging the second annular contact surface; and
a thrust bearing situated between the thrust flange and the brake caliper,
wherein the first radius has a first center point coincident with a longitudinal center axis of the screw shaft and the second radius has a second center point offset from the longitudinal center axis of the screw shaft.

16. A brake apparatus as set forth in claim 15, wherein the first radius has a first center point coincident with a longitudinal center axis of the screw shaft and the second radius has a second center point offset from the longitudinal center axis of the screw shaft.

17. A brake apparatus as set forth in claim 16, wherein the second radius is greater than the first radius.

18. A brake apparatus as set forth in claim 15, further comprising a bearing disc fixed to the brake caliper.

19. A brake apparatus as set forth in claim 15, wherein the linear actuator comprises a ball screw assembly having a plurality of balls located in opposing ball tracks defined in the screw shaft and the nut.
